(19) United States
(12) Patent Application Publication
(10) Pub. No.: US 2010/0152966 A1
(43) Pub. Date: Jun. 17, 2010

(54) AUTOMATIC LOCKING SYSTEM FOR MOTOR VEHICLE

(75) Inventor: Jean-Michel Tessier, Creteil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/295,841

(22) PCT Filed: Apr. 5, 2007
(86) PCT No.: PCT/EP07/53404

§ 371 Date: Oct. 2, 2008

(30) Foreign Application Priority Data
Apr. 7, 2006 (FR) 0603111

(51) Int. Cl. B60R 25/00

(52) U.S. Cl. 701/36

(57) ABSTRACT

The present invention relates to an automatic system for locking the openable panels of a motor vehicle, comprising a control unit carried on board the vehicle and able to communicate with an identifier; communication means establishing a communication between the onboard control unit and the identifier, installed in the vehicle, a device fitted with simultaneously fed antennas, the magnetic field of two adjacent antennas combining into a positive resultant so as to define an active zone around the vehicle, characterized in that the antenna device comprises three antennas disposed on each face and includes at least one openable panel.

### FIELD OF THE INVENTION

The present invention relates to an automatic locking system for motor vehicle and in particular for automatically locking all the openable panels (doors, trunks, tailgates, etc.), when the driver moves away from the vehicle.

### BACKGROUND OF THE INVENTION

So-called hands-free “intelligent” systems for vehicle access have made their appearance over the last few years. These devices allow the openable panels (doors, trunks, tailgate, etc.) to be unlocked without manual intervention by the user.

For this purpose, the user is furnished with a recognition means, or “identifier”, which enables a control unit on board the motor vehicle to recognize the authorized user, when the user is in proximity to an openable panel of the motor vehicle and, generally, when the user actuates the opening handle or any device for exterior opening control of the openable panel.

This recognition is generally performed by communication means establishing a bidirectional communication between the onboard control unit and the identifier.

The RF communication between the onboard control unit and the portable identifier is effected by way of a device furnished with antennas whose architecture varies from one system to another.

Among the devices used may be cited devices comprising a plurality of antennas disposed at the level of the exterior walls or at the level of the handles of the vehicle. These antennas, generally made in the form of a coil wound around a magnetic core, are energized sequentially so as to interrogate the identifier which may be situated anywhere around the vehicle. This solution operates well but it is often desirable to reduce the time required for the establishment of the interrogation of the identifier.

A solution has been found by employing devices extending right around the vehicle and comprising a single antenna, termed a fan antenna, made, for example, in the form of a fan of conducting wires. This antenna is integrated onto the canopy which is situated under the roof of the vehicle and, when energized, the antenna exhibits a homogeneous emission field around the vehicle. This makes it possible to interrogate the identifier wherever it is situated around the vehicle while having only one field emission.

In most cases, vehicles comprising a hands-free access system require an action by the user in order for the openable panels of the vehicle to lock. Generally, to activate the locking means, the user actuates a pushbutton situated on the door's exterior opening control.

To respond to growing demand from users, it has been proposed to carry out automatic locking of the vehicle, without manual actuation by the user, also called automatic locking.

In order to avoid untimely locking of the vehicle, the system must verify the presence of the identifier outside the vehicle. This verification is generally coupled with user authentication.

The difficulty of establishing this communication between the vehicle and the identifier, during locking, originates from the fact that the user may sometimes move rapidly away from his vehicle, or move into a zone not covered by the antenna device, such as for example when he fills his gas tank. The interrogation of the identifier by the onboard controller must therefore be done rapidly, after door closure, and the range of the monitoring zone covered by the antenna device, allowing this communication, must be sufficiently large and homogeneous around the vehicle so that the identifier of a user remaining in proximity to his vehicle is always visible by the onboard control unit.

Nevertheless, the extent of the monitoring zone must not be too large so as to comply with a regulatory anti-theft security requirement. Specifically, if the bearer of the identifier moves more than two meters away from his vehicle though the identifier, on account of the extent of the monitoring zone, is still considered to be in a zone close to the vehicle, an ill-intentioned individual can unconcernedly actuate one of the openable panels of the vehicle although its is already situated a large distance away.

A problem encountered when using a device furnished with a plurality of antennas stems from the fact that the sequential energizing of the antennas is not suited to the automatic locking of the vehicle. Specifically, the system will interrogate the presence of the identifier successively in the respective zone of coverage of each antenna. This process will take a certain time, and the user runs the risk of being confronted, while actuating the handle, with what is called the wall effect, that is to say non-opening of the actuated openable panel.

The devices using fan antennas positioned at the level of vehicle canopies are for their part well suited to automatic locking only for certain types of vehicle. Specifically, their integration is not always possible or well suited on account of the architecture of the vehicle.

A solution has been proposed in application EP1513109. It consists in energizing four antennas of ferrite type simultaneously, two of which are situated in the rear corners of the vehicle and the other two on the side faces of the vehicle. This solution still remains too expensive and also rather inflexible in terms of integrating the antennas onto the vehicles.

So the technical problem to be solved, by the subject of the present invention, is to propose an automatic locking system which makes it possible to avoid the problems of the prior art, and especially to decrease the cost of the device as regards number of antennas while retaining high flexibility of integration and high reliability of detection.

### SUMMARY OF THE INVENTION

Thus, it is apparent that it is particularly judicious to design an automatic system for locking all the openable panels of a motor vehicle, comprising a control unit carried on board the vehicle and able to communicate with an identifier; communication means establishing a communication between the onboard control unit and the identifier, installed in the vehicle, and a device furnished with simultaneously emitting antennas, the field of two adjacent antennas combining into a positive resultant so as to define an active zone around the vehicle, in which the device furnished with antennas comprises only three antennas.

According to a particular nonlimiting embodiment, the antennas emit between 120 and 138 kHz.

The present invention relates to an automatic system for locking all the openable panels of a motor vehicle, comprising a control unit carried on board the vehicle and able to communicate with an identifier; communication means establishing a communication between the onboard control unit and the identifier, installed in the vehicle, a device furnished with simultaneously energized antennas, the magnetic fields of two adjacent antennas combining into a positive resultant so as to define an active zone around the vehicle, characterized in that the antennas device comprises three antennas disposed on each face including at least one openable panel.

The term openable panels of a motor vehicle is understood to imply the side doors, the trunk or the tailgate.

The term active zone is understood to imply the zone around the vehicle wherein the intensity of the magnetic field, emitted by the antennas as a whole, is sufficient to be detected by the identifier.

The present invention also exhibits particularly advantageous secondary characteristics which will be presented in the description which follows.

### BRIEF DESCRIPTION OF THE DRAWINGS

The invention will be better understood in the course of the detailed explanatory description of nonlimiting examples referring to the appended figures.

FIG. 1 is a schematic view from above of a motor vehicle equipped with a plurality of low-frequency emitting/receiving antennas

FIG. 2 is a schematic view from above of the exterior active zones of the low-frequency emitting/receiving antennas

FIG. 3 schematically represents the manner in which the total active zone is constituted

FIG. 4 schematically defines the limit dimensional parameters of the total active zone

FIG. 5 schematically represents the total active zone obtained in the case of a long vehicle according to a preferential choice of integration of the low-frequency emitting/receiving antennas

FIG. 6 schematically represents the total active zone obtained in the case of a long vehicle according to a non-preferential choice of integration of the low-frequency emitting/receiving antennas

FIG. 7 is the functional chart for carrying out the automatic control for locking the openable panels.

### DETAILED DESCRIPTION

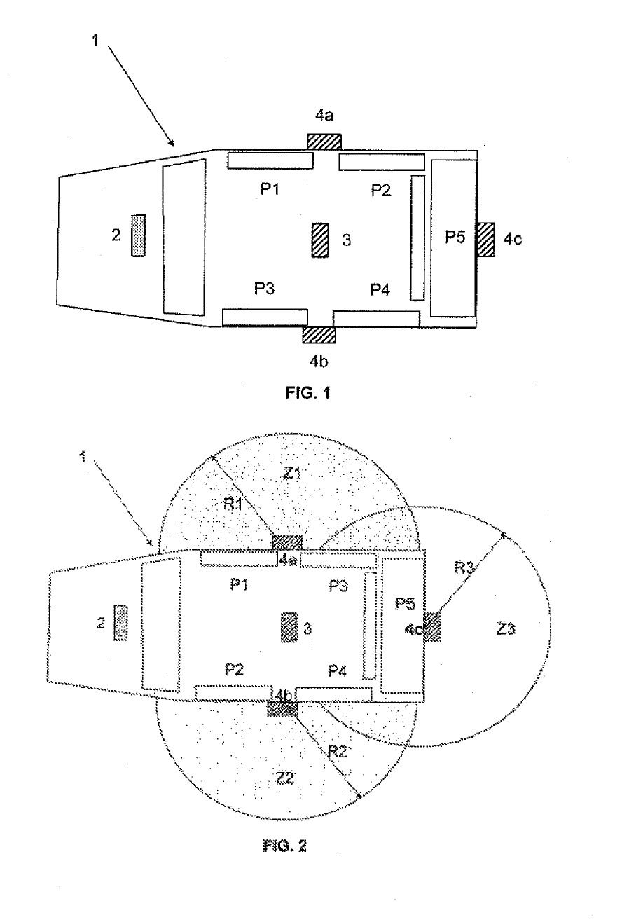

FIG. 1 illustrates a motor vehicle 1 equipped with a hands-free access device essentially comprising an onboard control unit 2 installed on the vehicle 1, and a portable identifier, not represented here, and with which the onboard control unit 2 communicates by radiofrequency waves. The vehicle 1 also comprises low-frequency emitting/receiving antennas, which include one or more low-frequency emitting/receiving antennas 3, covering the interior of the vehicle, and 3 low-frequency emitting/receiving antennas 4a, 4b, 4c covering the exterior of the vehicle and each disposed on a side (right, left, rear) of the vehicle which contains at least one openable panel P1 to P5.

The low-frequency emitting/receiving antennas 3, 4a, 4b, 4c consist of coils wound around a magnetic core such as ferrite, plastoferrite, a stack of nanocrystalline alloy sheets, etc.

According to the architecture of the vehicle, the low-frequency emitting/receiving antennas 4a, 4b disposed respectively on the right and left sides of the vehicle can be integrated into the openable panel handles, the door fittings, the side trims, or at any other location capable of receiving a low-frequency emitting/receiving antenna. With regard to the low-frequency emitting/receiving antenna 4c disposed at the rear, it can be integrated into the rear fender, into the trunk handle or tailgate handle, into the raised stoplight block, into the motor block of the rear windshield wiper, or at any other location capable of receiving a low-frequency emitting/receiving antenna.

FIG. 2 shows the zones of exterior coverage Z1, Z2, Z3 of each low-frequency emitting/receiving antenna 4a, 4b, 4c. These zones are shown diagrammatically by portions of disks of radius r1, r2, r3 centered on the antennas 4a, 4b and 4c. Each coverage zone Z1, Z2, Z3 corresponds to a zone where the intensity of the field emitted respectively by the antenna 4a, 4b, 4c is sufficient to be detected by the identifier.

In an advantageous manner, the low-frequency waves of the present invention are chosen in the vicinity of 125 kHz, but this value can vary, according to the country and/or the embodiment, in the range 10-300 kHz.

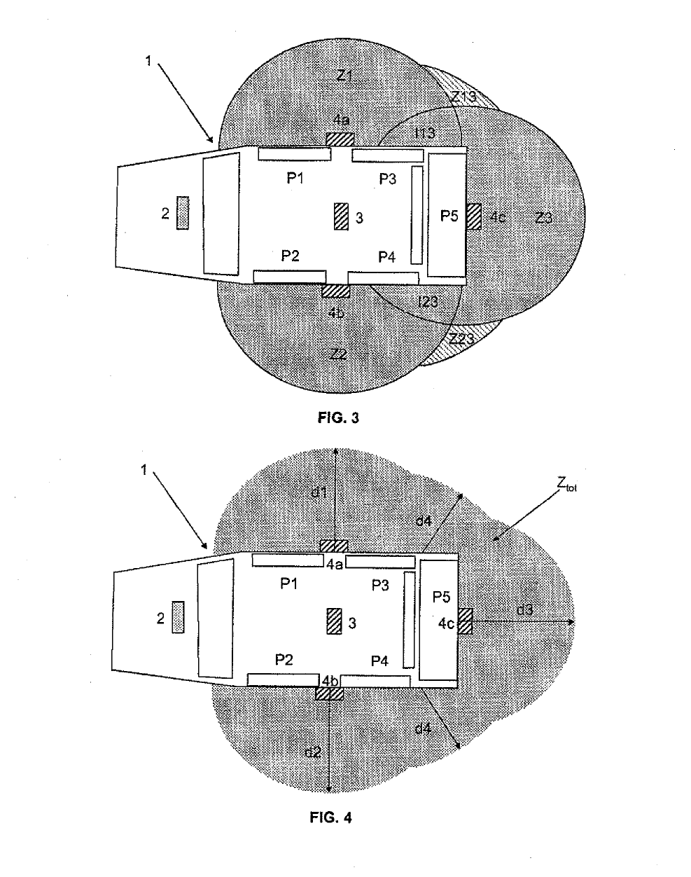

As represented in FIG. 3, and because the emitting/receiving antennas covering the exterior of the vehicle are energized simultaneously, this simultaneously yields the active zones Z1, Z2, Z3 produced individually by each of the emitting/receiving antennas 4a, 4b, 4c. Moreover, at the intersections I13, I23 of two adjacent zones, the fields combine into a positive resultant and the additional active zones

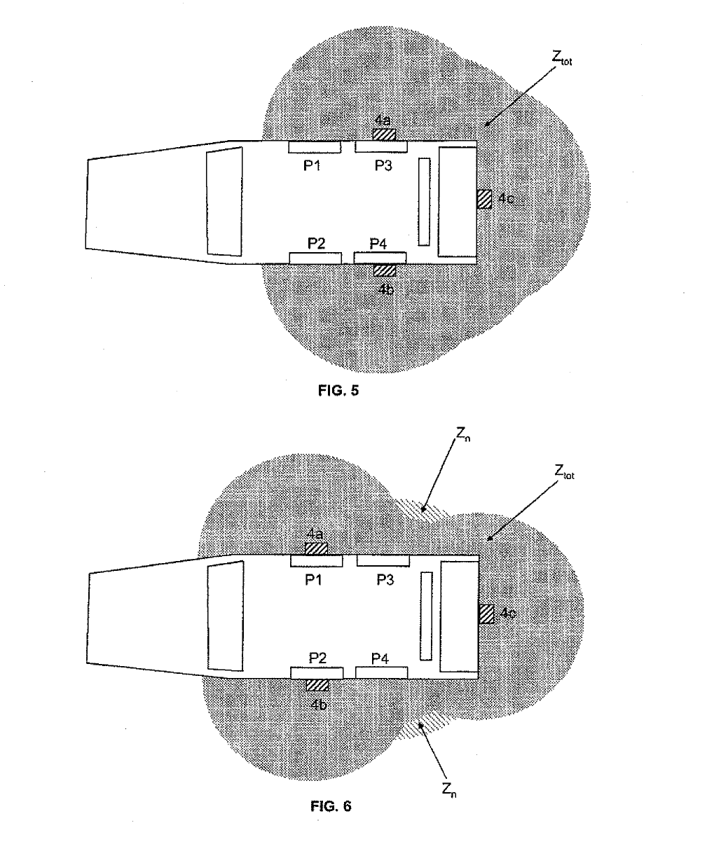

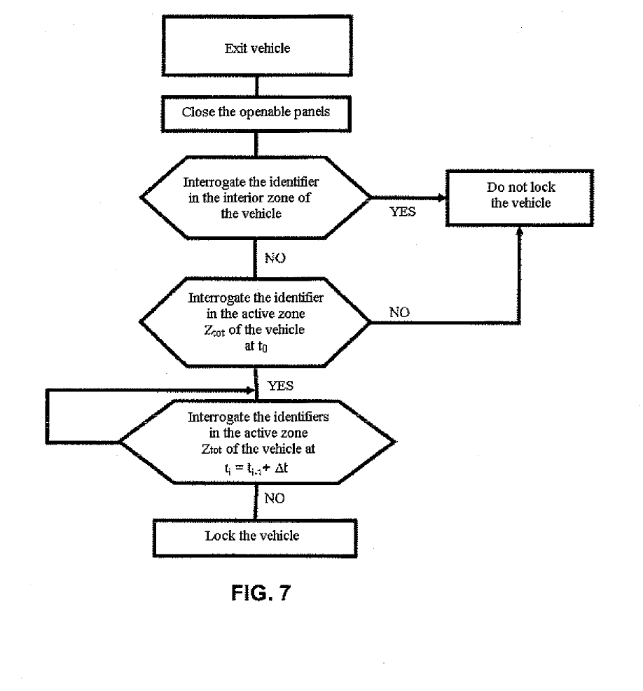

Z13 and Z23 are obtained. As represented in FIG. 5, the total active zone Zₜₒₜ is therefore the sum Z1+Z2+Z3+Z13+Z23.

The total active zone Zₜₒₜ thus forms a homogeneous detection zone outside the vehicle.

In FIG. 4 are indicated the distances d1, d2, d3 corresponding to the respective distance between the low-frequency emitting/receiving antenna and the monitoring zone limit Zₜₒₜ. To comply with Thatcham certification, the system will be dimensioned such that none of the distances d1, d2, d3 is greater than 2 meters (m). Specifically, Thatcham certification requires that the active zone of detection of the identifier be less than 2 m to prevent an ill-intentioned individual from actuating an openable panel although the user bearing an identifier has moved a reasonable distance away, but at which the identifier is still detectable. On the other hand, and so that the system is sufficiently effective to avoid untimely automatic locking, especially when the user stands close to the vehicle without moving away from it or when he heads towards the rear of the vehicle for example to fill up with gas, the system will be dimensioned such that none of the distances d1, d2, d3, d4 is less than 80 centimeters (cm).

As shown diagrammatically in FIG. 5, in the case of a long vehicle, and to comply with the previously specified constraints, it will be necessary to integrate the two low-frequency emitting/receiving antennas 4a, 4b, disposed respectively on the rear portions of the right and left side face of the vehicle. A total active zone Zₜₒₜ in accordance with the Thatcham specification and effective for avoiding untimely locking is thus obtained. On the other hand, if the two low-frequency emitting/receiving antennas 4a, 4b had been integrated respectively onto the front portions of the right and left side faces of the vehicle, then a total active zone Zₜₒₜ would have been obtained, as represented in FIG. 6, which, although complying with the Thatcham specification, exhibits zones Zn in which undesired locking could occur. The only means of avoiding these zones Zn is to increase the range of the low-frequency emitting/receiving antennas, but in this case a lack of compliance with the Thatcham specification will quickly ensue.

The steps of carrying out the automatic locking control are detailed in the functional chart of FIG. 5. When a user leaves the vehicle, the system first of all ensures that all the openable panels P1 to P5 are closed. The second step consists in verifying that the identifier is no longer in the cabin with the aid of one or more antennas 3, covering the interior of the vehicle without overflowing to the exterior, that is to say without it being possible to detect the identifier outside the vehicle. If the identifier is detected inside the cabin, the process stops and no automatic locking control occurs. If the identifier is not detected inside the vehicle, the process continues by verifying the presence of the identifier, outside the vehicle, in an active zone Zₜₒₜ. If the identifier is detected outside the vehicle in the active zone Zₜₒₜ, the operation of verifying the presence of the identifier in the active zone Zₜₒₜ is undertaken again. This step of verifying the presence of the identifier is repeated until the identifier is no longer detected in the active zone Zₜₒₜ. When the identifier is no longer detected in the active zone Zₜₒₜ, the system undertakes the automatic locking of all the openable panels.

1. An automatic system for locking a plurality of openable panels of a motor vehicle (1), comprising:
a control unit carried on board the vehicle and able to communicate with an identifier;
communication means establishing a communication between the onboard control unit and the identifier, wherein the communication means is installed in the vehicle; and
a device comprising simultaneously emitting antennas, wherein a field of two adjacent antennas combine into a positive resultant so as to define an active zone (Zₜₒₜ) around the vehicle,
wherein the device comprises three antennas disposed on each face of at least one of the plurality of openable panels.

2. The locking system as claimed in claim 1, wherein a first of the three antennas is positioned on a right side face of the vehicle, a second of the three antennas is positioned on a left side face of the vehicle, and a third of the three antennas is positioned on a rear face of the vehicle.

3. The locking system as claimed in claim 1, wherein a distance between an exterior limit of the active zone (Zₜₒₜ) and an exterior contour of the vehicle lies between 80 cm and 2 m.

4. The locking system as claimed in claim 2, wherein the first and second antennas positioned on the right and left side faces are integrated into one selected from a group consisting of handles of the corresponding openable panels, side trims of the vehicle, and tops of door fittings of the vehicle.

5. The locking system as claimed in claim 2, wherein the third antenna positioned on the rear face of the vehicle is integrated into one selected from a group consisting of a handle of the rear openable panel, a rear fender, a raised stoplight block, and a motor block of a rear windshield wiper of the vehicle.

6. The locking system as claimed in claim 1, wherein each of the three antennas comprise a coil wound around a magnetic core.

7. The locking system as claimed in claim 6, wherein the magnetic core is one of ferrite, plastoferrite, and a stack of nanocrystalline alloy sheets.

8. The locking system as claimed in claim 1, wherein each of the three antennas emit between 120 and 138 kHz.

9. A motor vehicle comprising the locking system as claimed in claim 1.
